(19) United States
(12) Patent Application Publication
(10) Pub. No.: US 2011/0136071 A1
(43) Pub. Date: Jun. 9, 2011

(54) BRACE CAP

(75) Inventor: Lawrence J. LEVENS, Houston, TX (US)

(73) Assignee: ORTHOACCEL TECHNOLOGIES, INC., Houston, TX (US)

(21) Appl. No.: 12/888,280

(22) Filed: Sep. 22, 2010

Related U.S. Application Data
(60) Provisional application No. 61/250,343, filed on Oct. 9, 2009.

(51) Int. Cl. A61C 7/28

(52) U.S. Cl. 433/13

(57) ABSTRACT

Vibrating dental devices and accessories are provided, including a unique snap fit dental plate and vibrator connection; risers for adjusting the thickness of a dental plate; a pointer or wand that can be clamped onto a dental plate to reach even severely misaligned teeth; a cushioned dental plate having a non-Newtonian fluid therein that allows conformation of the cushion to the dentition, but hardens on use to allow the transmission of vibration to the teeth. Accessories such as carrying cases and docking stations are also provided.

### PRIOR RELATED APPLICATIONS

This application claims priority to U.S. Provisional Application Ser. No. 61/250,343, filed on Oct. 9, 2009, which is incorporated herein in its entirety.

### FEDERALLY SPONSORED RESEARCH STATEMENT

Not applicable.

### REFERENCE TO MICROFICHE APPENDIX

Not applicable.

### FIELD OF THE INVENTION

The invention relates to a brace cap that fits over the end of orthodontic braces, which protects the patient from the arch wire protruding therefrom.

### BACKGROUND OF THE INVENTION

Orthodontics is a dental specialty that treats malocclusion through the movement of teeth as well as control and modification of facial growth. This process is usually accomplished by using a continuous mechanical force to induce bone remodeling, thereby enabling the teeth to move to a better position. In this approach, orthodontic appliances provide a continuous static force to the teeth, usually via an archwire connected to brackets affixed to each tooth. As the teeth slowly move due to the force, the arch wires are adjusted to increase the force. Although effective, this widely accepted approach takes about twenty four months on average to achieve success.

Orthodontic braces like these have been around for more than 50 years, and many patents are directed to various improvements thereon, some more successful than others. However, most commercial brace designs still call for the basic brackets that are attached to one or more teeth, generally with a cement or adhesive, and force is then applied via an archwire that connects the brackets and can be tightened as the teeth remodel under pressure. See e.g., U.S. Pat. No. 502,285, U.S. Pat. No. 5,238,404, U.S. Pat. No. 5,609,482 and the like.

U.S. Pat. No. 6,276,931, for example, describes a modern bracket (shown in FIG. 1). While the details may vary, generally speaking brackets have a pair of railings and a slot for receiving the archwire. In use, current orthodontic braces present a particular problem at the distal ends of the archwire, which protrudes from the bracket and can irritate or injure sensitive mouth tissues.

The problem is commonly recognized and no satisfactory solution has been proposed. In fact, when an archwire of ligature wire is poking a patient, the American Association of Orthodontics recommends:
Use a Q-tip or pencil eraser to push the wire (see diagram) so that it is flat against the tooth. If the wire cannot be moved into a comfortable position, cover it with relief wax. (See “Irritation of Cheeks or Lips” below for instructions on applying relief wax.) Make the orthodontist aware of the problem. If the end of an orthodontic archwire (see diagram) is poking in the back of the mouth, attempt to put wax over the area to protect the cheek. Call the orthodontist to schedule an appointment and have that clipped. If you are uncomfortable, make sure you inform the orthodontist.
In a situation where the wire is extremely bothersome and the patient will not be able to see the orthodontist immediately, as a last resort, the wire may be clipped with an instrument such as fingernail clippers.

Clearly, bending the wire, daubs of wax, and clipping archwires present unsatisfactory solutions. What is needed in the art is device or method for preventing the ends of the archwire from damaging sensitive mouth tissue.

### SUMMARY OF THE INVENTION

The invention relates to a disposable cap that snap fits over the terminal bracket of an orthodontic brace, thus covering the protruding archwire and protecting the patient from irritation. The exterior of the cap should also be flat or smoothly rounded or combinations thereof for maximal patient comfort. The cap has interior hollow designed to perform two functions. First, a portion of the hollow is shaped to snap fit over a typical bracket, thus prevented the cap from easily coming off the archwire. To this end, different caps may need to be made for different bracket systems or tailored brackets that are in commercial use. The second function is that of containing the archwire. A hollow inside the cap will accept the archwire as it protrudes from the bracket, and preferably guides it back in the opposite direction as the wire increasingly protrudes during remodeling. Thus, in preferred embodiments the interior archwire space is also smoothly curved.

In preferred embodiments the cap is made of a semi flexible material, resilient enough to allow a snap fit over the bracket but strong enough for use. Polymers such as silicone rubber, polyethylene (PE), high density PE (HDPE), polycarbonate, polyurethane, polypropylene (PP), polyvinylchloride (PVC), polymethyl methacrylate, polyvinylidene fluoride, polyesters, acrylics, vinyl, nylon, rubber, latex, Teflon, or similar material may be suitable for cap material, as well as metals, alloys, ceramics and the like. Preferably, the polymer will not have an objectionable taste and will be FDA approved, such as silicone rubber, polypropylene, HDPE, and the like. The cap can also comprise two materials, and inner layer for strength and structural integrity, and a more pleasing outer coating for patient compliance.

In preferred embodiments, the cap is injection molded as a single plastic piece. Preferably, the plastic has a durometer rating (ASTM D2240) of less than 100 Shore A and preferably less than 90 or 80 or 70 shore, and most preferably between about 10-40 Shore A. The cap also preferably has a thickness of 0.5-5 mm and preferably 1-2 mm. Thickness can vary according to the durometer of the plastic—a plastic with more stiffness generally needing to be thinner to achieve the pliability needed for a snap fit. Translucent or clear plastic that allows the user to easily and accurately position the cap over the bracket during application is also preferred, although even opaque plastics can become translucent if sufficiently thin.

### BRIEF DESCRIPTION OF THE DRAWINGS

FIG. 1 shows a typical bracket.

FIG. 2 shows a typical orthodontic braces and the various subparts thereof.

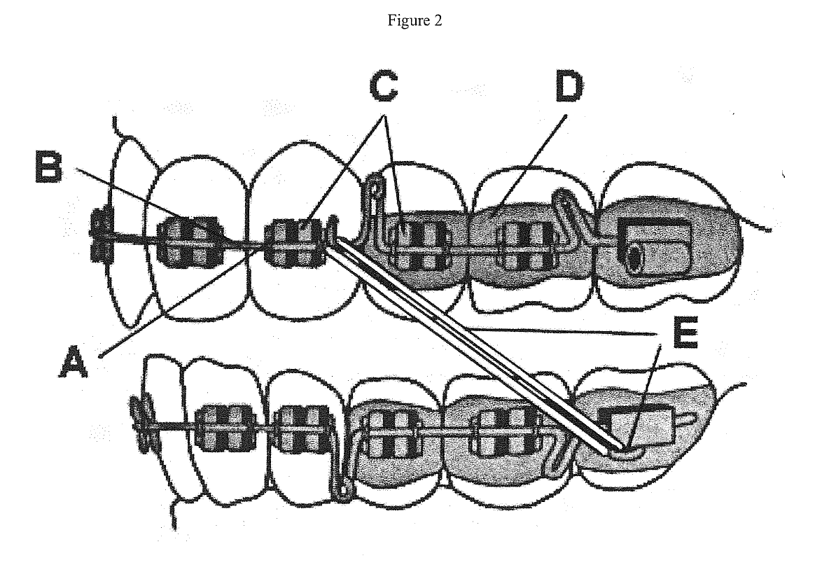

FIG. 3 provides dental nomenclature.

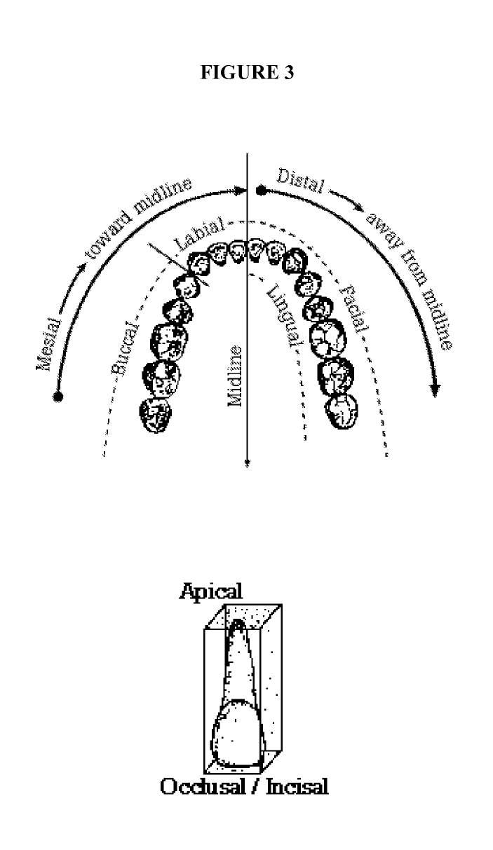

FIG. 4 provides a bracket and cap in perspective.

FIG. 5 shows the same bracket from the open end.

### DESCRIPTION OF EMBODIMENTS OF THE INVENTION

The following examples are illustrative only.

### Example 1

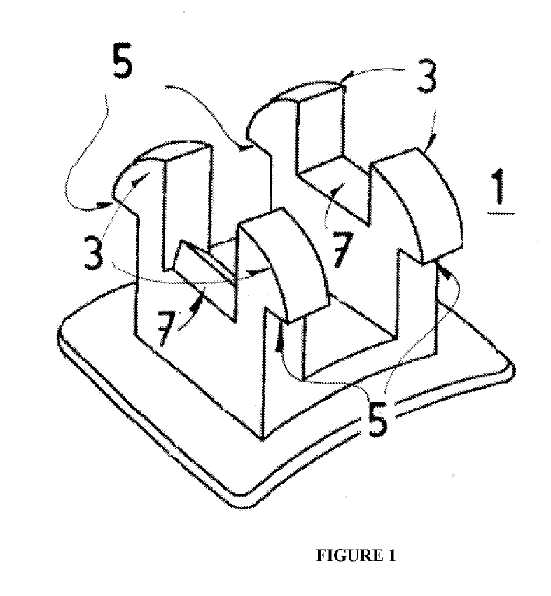

A typical orthodontic bracket 1 is shown in FIG. 1, wherein a pair of rails 3 are shown, along with a slot 7 into which the archwire (not shown) fits. Recessions 5 are typically found on a bracket into which rubber bands fit, thus holding the archwire in place.

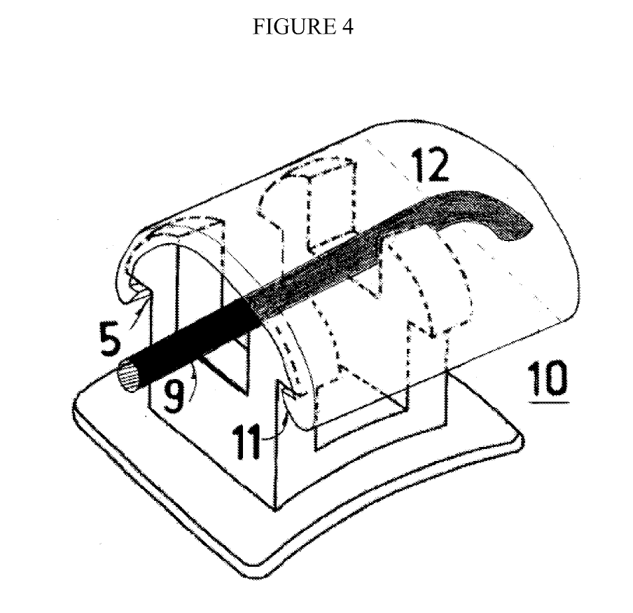

A brace cap 10 is shown fitting on a typical bracket in FIG. 4. Generally speaking the cap has an open end and an open bottom, to accommodate the teeth and braces. However, the top and other end are closed. The exterior surface thus partially encloses an interior hollow.

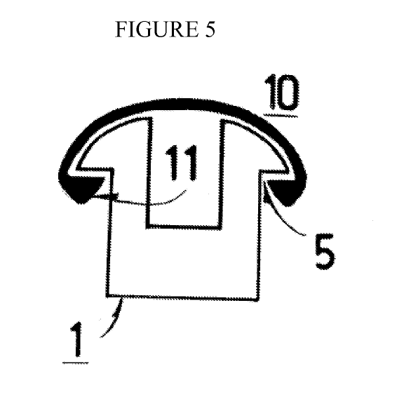

More particularly, archwire 9 fits into the slot 7 (not labeled) of a bracket (not labeled) and fits into the hollow 12 or space in the end of brace cap 10. Protrusions 11 fit into the recessions 5 on bracket 1 (not labeled), thus providing a snap fit, but obviously these can be reversed, the cap providing the recessions and the bracket having protrusions. The same bracket is show from the open end in FIG. 5 which more clearly illustrates protrusions 11 fitting into recession 5. The shape of the protrusion (in this case a cantilevered snap fit) ensures that the brace cap will easily snap fit over the brace, and the general smoothness of the exterior also ensures comfort.

To apply the brace cap, the cap is fitted over the brace and a small amount of pressure is applied, sufficient to push the edges of the cap slightly apart, allowing the cap to snap fit to the bracket-the protrusions fitting into the recessions. For removal, a fingernail applied on one edge of the cap can lift the edge of the cap, freeing the protrusion from the recession and allowing removal.

The following references described herein are expressly incorporated in their entirety:
U.S. Pat. No. 502,285
U.S. Pat. No. 5,238,404
U.S. Pat. No. 5,609,482
U.S. Pat. No. 6,276,931

What is claimed is:

1. A brace cap, comprising a cap having an open end, an open base, a closed end, a closed top, an exterior surface, and an interior hollow, said exterior surface being smooth and said interior hollow being shaped to snap fit over an orthodontic bracket and to hold a end of an archwire.

2. The brace cap of claim 1, wherein said cap is made of a flexible polymeric material.

3. The brace cap of claim 1, wherein said cap is injection molded of a flexible polymeric material.

4. The brace cap of claim 1, wherein said cap is made of a translucent plastic.

5. The brace cap of claim 1, wherein said cap is made of a clear plastic.

6. The brace cap of claim 1, wherein said snap fit is a cantilevered snap fit.

7. The brace cap of claim 1, wherein said cap is made of a flexible polymeric material having a durometer of less than 70 Shore A and said cap having a thickness of about 0.5-5 mm.

8. The brace cap of claim 1, wherein said cap is made of a flexible polymeric material having a durometer of about 10-40 and said cap having a thickness of about 0.5-2 mm.

9. The brace cap of claim 1, wherein said cap is made of a flexible polymeric material having a durometer of about 10-40 Shore A and said cap having a thickness of about 0.5-2 mm and being injection molding of a translucent plastic.

10. The brace cap of claim 1, wherein said cap is made of a flexible polymeric material having a durometer of about 10-40 Shore A and said cap having a thickness of about 0.5-2 mm and being injection molding of a clear plastic.
